(19) United States
(12) Patent Application Publication
(10) Pub. No.: US 2025/0209764 A1
(43) Pub. Date: Jun. 26, 2025

(54) INFORMATION PROCESSING SYSTEM AND METHOD OF CONTROLLING INFORMATION PROCESSING SYSTEM CAPABLE OF PROVIDING COMPOSITE IMAGE OF PLURALITY OF IMAGES

(71) Applicant: CANON KABUSHIKI KAISHA, Tokyo (JP)

(72) Inventor: NAOHITO NAKAMURA, Kanagawa (JP)

(21) Appl. No.: 18/989,796

(22) Filed: Dec. 20, 2024

(30) Foreign Application Priority Data
Dec. 26, 2023 (JP) 2023-219229

(51) Int. Cl. G06T 19/20

(52) U.S. Cl. CPC G06T 19/20; G06T 2219/2021

(57) ABSTRACT

An information processing system includes a first information processing apparatus that stores information of a first object, and a second information processing apparatus that stores information of a second object different from the first object. The first information processing apparatus generates a first image including a rendering of the first object, on the basis of position-orientation information of a first body and information of the first object. The second information processing apparatus generates a second image including a rendering of the second object, on the basis of the position-orientation information of the first body and information of the second object. The first information processing apparatus further generates an image that is a composite of the first image and the second image.

### BACKGROUND OF THE INVENTION

### Field of the Invention

The present invention relates to an information processing system and a method of controlling an information processing system.

### Description of the Related Art

Currently, virtual reality (VR) and mixed reality (MR) systems are being vigorously developed for the purpose of enabling seamless unification of a real space and a virtual space. Also currently under development are systems for enabling a plurality of users to share the states of a virtual body over a network. With such a system, when one user edits (operates) a virtual body, the change is reflected to the virtual body to be perceived by the other users, so that a plurality of users can edit the same body in collaboration.

Such a system renders the virtual space on the basis of position-orientation information of users and information of virtual bodies. However, an information processing apparatus used in rendering such a virtual space only has a finite amount of computational resources. Therefore, merely with a single information processing apparatus, sometimes it is challenging to make high-quality rendering of an enormous number of virtual bodies.

As a solution to such a challenge, according to Japanese Patent Application Laid-open No. 2004-348702, a plurality of three-dimensional objects are classified into different groups, and different rendering units are caused to render three-dimensional objects belonging to the respective groups. Each pixel of the three-dimensional objects thus rendered has depth information corresponding to that pixel, and such depth information is used in integrating the three-dimensional objects rendered by the plurality of respective rendering units.

Japanese Patent Application Laid-open No. 2018-077555 discloses a system in which a plurality of objects are classified into two categories on the basis of instructions that are based on user operations, and a terminal device and a server device execute rendering of the objects belonging to the respective categories, and the resultant objects are composited on the terminal device.

With the technology described above, compositing of the three-dimensional objects is made possible by retaining all of three-dimensional objects to be composited at one location, or retaining the same three-dimensional objects at each of a plurality of locations. In other words, at least one device needs to have the information of all of the three-dimensional objects to be included in a composite image of a plurality of images.

### SUMMARY OF THE INVENTION

An object of the present invention is to enable to a composite image of a plurality of images to be provided without requiring at least one device to retain information of all three-dimensional objects.

An aspect of the invention is an information processing system including a first information processing apparatus that stores information of a first object, and a second information processing apparatus that stores information of a second object different from the first object, wherein the first information processing apparatus performs first generating processing to generate a first image including a rendering of the first object, based on position-orientation information of a first body and information of the first object, the second information processing apparatus performs second generating processing to generate a second image including a rendering of the second object, based on the position-orientation information of the first body and information of the second object, and the first information processing apparatus further performs first compositing processing to generate an image that is a composite of the first image and the second image.

An aspect of the invention is a method of controlling an information processing system including a first information processing apparatus that stores information of a first object, and a second information processing apparatus that stores information of a second object different from the first object, the method including: a first generating step of generating a first image including a rendering of the first object, based on position-orientation information of a first body and information of the first object, on the first information processing apparatus; a second generating step of generating a second image including a rendering of the second object based on the position-orientation information of the first body and information of the second object, on the second information processing apparatus; and a first compositing step of generating an image that is a composite of the first image and the second image on the first information processing apparatus.

Further features of the present invention will become apparent from the following description of exemplary embodiments with reference to the attached drawings.

### BRIEF DESCRIPTION OF THE DRAWINGS

FIG. 1 is a schematic illustrating an information processing system according to a first embodiment;

FIG. 2 is a flowchart of an MR image generating process according to the first embodiment;

FIGS. 3A to 3G are schematics for explaining images according to the first embodiment;

FIG. 4 is a schematic illustrating an information processing system according to a second embodiment;

FIG. 5 is a flowchart of an MR image generating process according to the second embodiment;

FIGS. 6A to 6G are schematics for explaining an image according to the second embodiment; and

FIG. 7 is a schematic of a hardware configuration of an information processing apparatus according to a third embodiment.

### DESCRIPTION OF THE EMBODIMENTS

Some embodiments for implementing the present invention will now be explained in detail with reference to the appended drawings. The embodiments described below are merely some example of the means for implementing the present invention, and may be modified or changed on the basis of a configuration of the device to which the present invention is applied, or on the basis of various conditions. The present invention should not be construed as being limited to the embodiments described below.

### First Embodiment

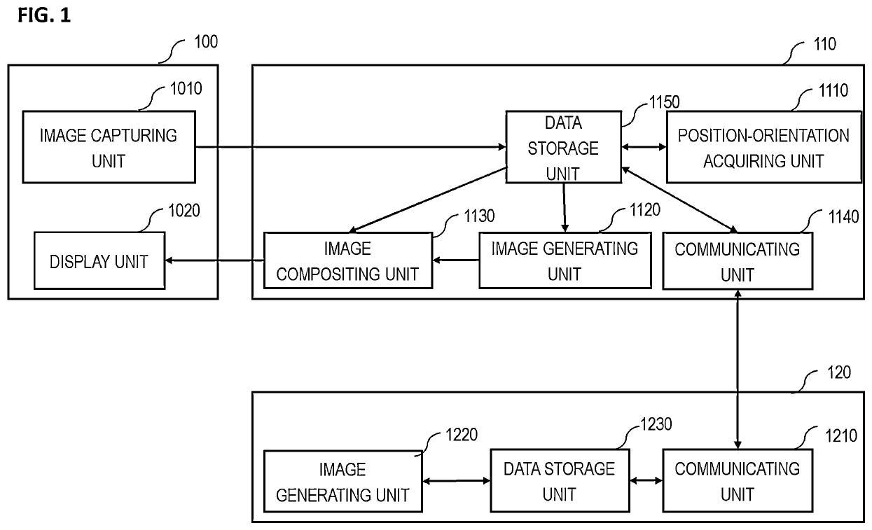

As illustrated in FIG. 1, an information processing system according to a first embodiment includes a display device 100, an information processing apparatus 110, and an information processing apparatus 120. In the first embodiment, each of the information processing apparatus 110 and the information processing apparatus 120 may be a server device or a personal computer (PC), or may be configured as a cloud.

The display device 100 is, for example, a head-mounted display device (HMD) that is one example of a head-wearable device. In the first embodiment, the display device 100 may be other types of a head-wearable display device. For example, the display device 100 may be a hand-held display device. A hand-held display device is a type of head-wearable display device worn on (held against) the head of a user who is holding the display device by hand. Some examples of a hand-held display devices is a smartphone and a tablet terminal.

The display device 100 may be a pair of smart glasses (augmented reality (AR) glasses). Smart glasses are one type of the head-wearable display device. The display device 100 may be a head-wearable display device by which a user perceives an image using both eyes, or a head-wearable display device by which the user perceives an image with only one eye. The display device 100 may be a smartphone mounted on a head-mount adaptor (e.g., virtual reality (VR) goggles). The display device 100 may also be a display device other than a head-wearable display device (e.g., desktop display device).

The display device 100 may be a device using either a video-see through system or an optical see-through system. In the video-see through system, for example, an image of the real space (outer world) being captured by an image capturing device (such as a video camera) is displayed on a display surface (a display surface not passing through the light from the real space) in real time. Graphics (e.g., images of virtual bodies) are then displayed in a manner superimposed over (composited with) the image of the real space. In such a case, although the user cannot see the real space directly, the user can see not only the real space indirectly, but also the graphics superimposed over the image of the real space, by perceiving the displayed image.

In the optical see-through system, for example, graphics (e.g., images of virtual objects) are displayed on a display surface (a display surface passing through the light from the real space (outer world)). In such a case, the user can perceive the real space (outer world) directly through the display surface, as well as the graphics displayed on the display surface.

The information processing apparatus 110, the display device 100, and the information processing apparatus 120 are data-communicably connected to one another, for example. The information processing apparatus 110, the display device 100, and the information processing apparatus 120 may be connected over the wire or wirelessly. The whole or a part of the information processing apparatus 110 may be disposed inside the housing of the display device 100.

The display device 100 is provided with an image capturing unit 1010 and a display unit 1020.

The image capturing unit 1010 captures images of the real space temporally continuously, and outputs the captured images of the real space to the information processing apparatus 110. The image capturing unit 1010 may also include a stereo camera. The stereo camera includes two cameras that are fixed in a manner enabled to capture images of the real space from the positions near the respective eyes of the user, for example, along the direction of the line of sight of the user.

The display unit 1020 displays an MR image output from the information processing apparatus 110. The display unit 1020 may include displays disposed correspondingly to the left eye and the right eye of the user, respectively. In such a case, an MR image for the left eye is displayed on the display corresponding to the left eye of the user, and an MR image for the right eye is displayed on the display corresponding to the right eye of the user.

The information processing apparatus 110 includes a position-orientation acquiring unit 1110, an image generating unit 1120, an image compositing unit 1130, a communicating unit 1140, and a data storage unit 1150.

The position-orientation acquiring unit 1110 calculates the position-orientation (the position and the orientation) of the image capturing unit 1010 (the display device 100) within a world coordinates system. Specifically, the position-orientation acquiring unit 1110 extracts a marker assigned to the world coordinate system, from an image of the real space, captured by the image capturing unit 1010. The position-orientation acquiring unit 1110 then calculates, on the basis of the position-orientation of the marker, the position-orientation of the image capturing unit 1010 within the world coordinate system. The position-orientation acquiring unit 1110 then outputs the calculated position-orientation information of the image capturing unit 1010 to the data storage unit 1150.

There are various methods for calculating the position-orientation of the image capturing unit 1010, without limitation to the method described above. For example, the position-orientation acquiring unit 1110 may obtain the position-orientation of the image capturing unit 1010 or the position-orientation of a local coordinate system by performing a process of simultaneous localization and mapping (SLAM), on the basis of feature points included in the image. When the display device 100 includes a sensor having a known relative position-orientation with respect to the image capturing unit 1010, the position-orientation acquiring unit 1110 may also obtain the position-orientation of the image capturing unit 1010 by converting measurements of the sensor on the basis of the relative position-orientation. The position-orientation acquiring unit 1110 may also use a motion capture system to obtain the position-orientation of the image capturing unit 1010.

The image generating unit 1120 generates a virtual image (hereinafter, referred to as a “first virtual image”) by rendering a virtual space on the basis of data of the virtual space stored in the data storage unit 1150. The data of the virtual space includes data of one or more virtual bodies (virtual objects) included in the virtual space. The data of the virtual space also includes data related to a reality-approximating body that is information of the three-dimensional shape of a real body in the real space, the three-dimensional shape being plotted in the virtual space, as well as data related to a light source illuminating the interior of the virtual space. The image generating unit 1120 generates an image of the virtual space perceived from a viewpoint that is based on the position-orientation calculated by the position-orientation acquiring unit 1110, as a first virtual image. That is to say, the image generating unit 1120 generates a first virtual image by rendering a first virtual body inside a virtual space, on the basis of the data of the virtual space that at least includes data of the first virtual body, and the position-orientation of the image capturing unit 1010, for example. The first virtual body may be a three-dimensional object that is a representation of a body that is actually disposed in the real space. Because the technology for generating an image of the virtual space perceived from a viewpoint based on a predetermined position-orientation is a known technology, detailed explanations of such a technology will be omitted.

The image generating unit 1120 also generates a depth image corresponding to the generated first virtual image (hereinafter, referred to as a “first depth image”). A depth image herein is an image each pixel of which is set with depth information representing the distance to a body included in the first virtual image (a distance in a specific direction). In other words, depth information indicating the distance to a body represented in a pixel at coordinates (x, y) of the first virtual image (the distance of the body from a reference position) is set to a pixel corresponding thereto at the coordinates (x, y) of the first depth image. The image generating unit 1120 then outputs the first virtual image and the first depth image to the image compositing unit 1130.

The image compositing unit 1130 composites the first virtual image with a virtual image generated by the information processing apparatus 120 (hereinafter, referred to as a “second virtual image”). Before compositing these images, the image compositing unit 1130 compares the first depth image with a depth image corresponding to the second virtual image (hereinafter, referred to as a “second depth image”), and determines which one of the first virtual image and the second virtual image is nearer to the viewpoint, in units of pixels. The image compositing unit 1130 then composites the two virtual images in such a manner that the pixels of the virtual image nearer to the viewpoint are shown. The image compositing unit 1130 then generates an MR image by compositing the composite of the two virtual images with a real space image captured by the image capturing unit 1010. The image compositing unit 1130 then outputs the generated MR image to the display unit 1020.

The communicating unit 1140 transmits the position-orientation information of the image capturing unit 1010, the position-orientation information having been calculated by the position-orientation acquiring unit 1110, to the information processing apparatus 120. The communicating unit 1140 receives the second virtual image and the second depth image from the information processing apparatus 120.

As mentioned earlier, the data storage unit 1150 stores therein various types of information. The data storage unit 1150 includes a random access memory (RAM) or a hard disk drive device, for example. The data storage unit 1150 also stores therein information described as known information.

The information processing apparatus 120 includes a communicating unit 1210, an image generating unit 1220, and a data storage unit 1230.

The communicating unit 1210 receives the position-orientation information of the image capturing unit 1010 from the information processing apparatus 110. The communicating unit 1210 then outputs the position-orientation information of the image capturing unit 1010 to the data storage unit 1230. The communicating unit 1210 also transmits the second virtual image and the second depth image generated by the image generating unit 1220 to the information processing apparatus 110.

The image generating unit 1220 generates the second virtual image on the basis of the data of the virtual space stored in the data storage unit 1230. The data of the virtual space includes the data related to the light source illuminating the interior of the virtual space, and data related to one or more virtual bodies included in the virtual space (one or more virtual bodies that are different from the virtual bodies stored in the information processing apparatus 110). At this time, the data of the virtual space does not include the data of the virtual bodies that are used in generating the first virtual image. The data of the virtual bodies stored in the information processing apparatus 110 is not stored in the information processing apparatus 120. The data of the virtual bodies stored in the information processing apparatus 120 is not stored in the information processing apparatus 110, either. The image generating unit 1220 then generates a virtual image (virtual image) perceived from a viewpoint corresponding to the position-orientation of the image capturing unit 1010, as a second virtual image. Therefore, the image generating unit 1220 generates the second virtual image including a rendering of the data of a second virtual body different from the first virtual body, in the virtual space, on the basis of the data of the virtual space at least including the second virtual body and on the basis of the position-orientation of the image capturing unit 1010, for example. The second virtual body may be a three-dimensional object representing a body actually disposed in the real space.

The image generating unit 1220 also generates a second depth image corresponding to the second virtual image. The image generating unit 1220 then outputs the second virtual image and the second depth image to the data storage unit 1230.

The data storage unit 1230 stores therein various types of information. The data storage unit 1230 is implemented as a RAM or a hard disk drive device, for example. The data storage unit 1230 also stores therein information described as known information.

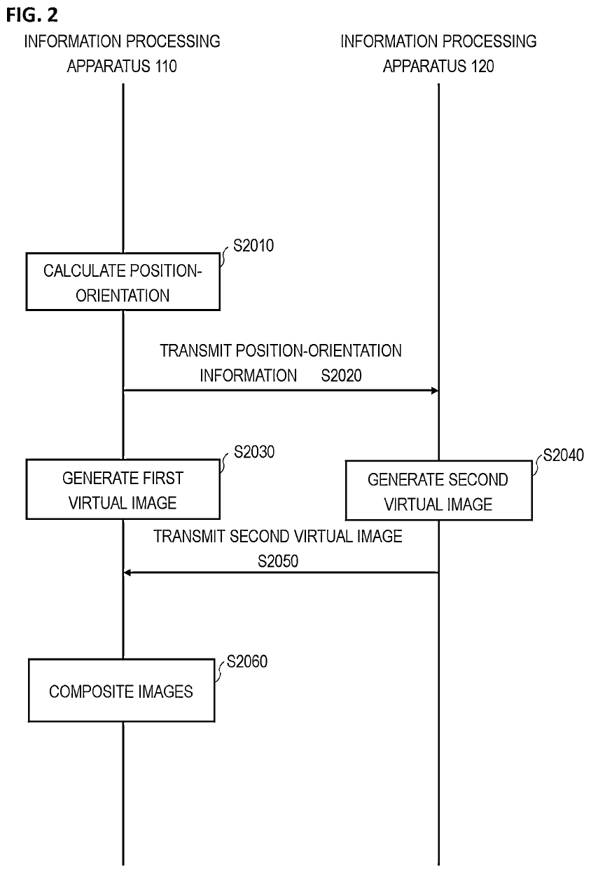

A process in which the information processing apparatus 110 and the information processing apparatus 120 generate and output an MR image to the display device 100 will now be explained with reference to the flowchart in FIG. 2.

At Step S2010, the position-orientation acquiring unit 1110 calculates the position-orientation of the image capturing unit 1010.

At Step S2020, the communicating unit 1140 transmits the position-orientation information of the image capturing unit 1010 to the information processing apparatus 120.

At Step S2030, the image generating unit 1120 generates a first virtual image and a first depth image, on the basis of the position-orientation of the image capturing unit 1010.

At Step S2040, the image generating unit 1220 generates a second virtual image and a second depth image, on the basis of the position-orientation of the image capturing unit 1010, substantially simultaneously with the process at Step S2030.

At Step S2050, the communicating unit 1210 transmits the second virtual image and the second depth image to the information processing apparatus 110.

At Step S2060, the image compositing unit 1130 composites the first virtual image, the second virtual image, and a real image acquired by the image capturing unit 1010. In this manner, the image compositing unit 1130 generates an MR image.

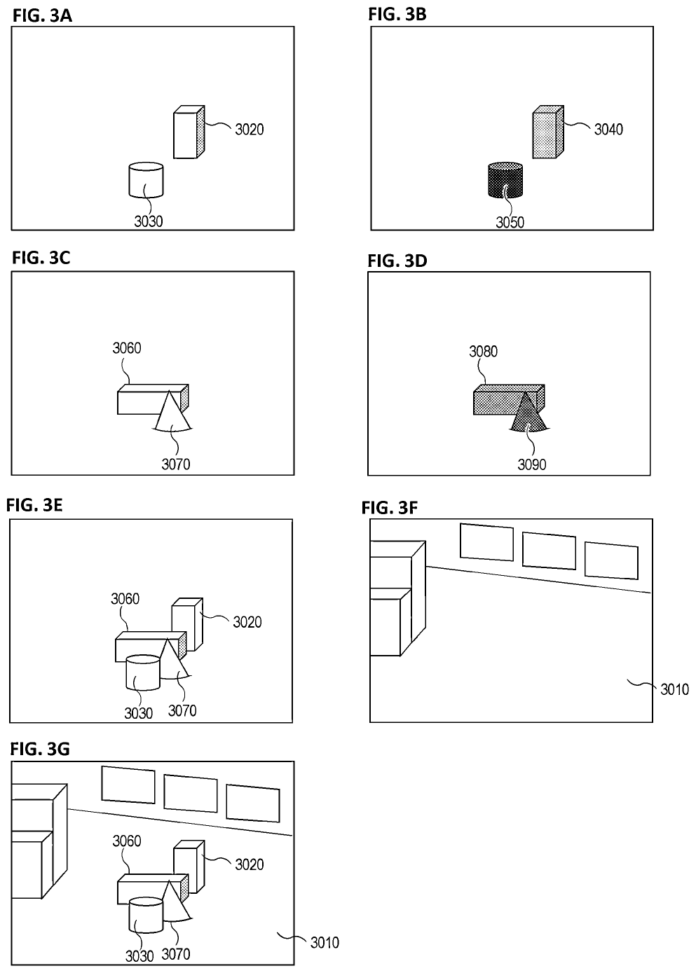

FIGS. 3A to 3G are schematics illustrating examples of the virtual image, the depth image, and the MR image.

A real image 3010 is an image representing the real space. The real image 3010 is an image resultant of causing the image capturing unit 1010 to capture an image of the real space.

A virtual body 3020 and a virtual body 3030 illustrated in FIG. 3A are three-dimensional objects stored in the data storage unit 1150. A region 3040 illustrated FIG. 3B is a region where a rendering of the virtual body 3020 is included in the first depth image generated by the image generating unit 1120. A region 3050 is a region where a rendering of the virtual body 3030 is included in the first depth image.

A virtual body 3060 and a virtual body 3070 illustrated FIG. 3C are three-dimensional objects stored in the data storage unit 1230. A region 3080 illustrated FIG. 3D is a region where a rendering of the virtual body 3060 is included in the second depth image. A region 3090 is a region where a rendering of the virtual body 3070 is included in the second depth image.

FIG. 3A illustrates the first virtual image generated by the image generating unit 1120. FIG. 3B illustrates first depth image generated by the image generating unit 1120. A depth image is a monochromatic image. Each pixel of a depth image is set with a value that is based on a distance between a reference position (viewpoint of the display device 100) and a virtual body. In a depth image, pixels with a virtual body nearer to the reference position are represented in darker colors, and pixels with a virtual body farther away from the reference position are represented in lighter colors. The distance between the virtual body 3030 and the reference position is shorter than the distance between the virtual body 3020 and the reference position. The region other than the virtual body 3030 and the virtual body 3020 includes no rendering of bodies. Therefore, in FIG. 3B, the region 3050 is a region darker than the region 3040, and the color of the other region is white.

FIG. 3C illustrates the second virtual image generated by the image generating unit 1220. FIG. 3D illustrates the second depth image generated by the image generating unit 1220. The distance between the virtual body 3070 and the reference position is shorter than the distance between the virtual body 3060 and the reference position. The region other than the virtual body 3070 and the virtual body 3060 includes no rendering of bodies. Therefore, in FIG. 3D, the region 3090 is a region darker than the region 3080, and the color of the other region is white.

FIG. 3E illustrates a composite image of the first virtual image illustrated FIG. 3A and the second virtual image illustrated FIG. 3C, the composite image being composited by the image compositing unit 1130, on the basis of a positional relationship between the virtual bodies in the depth direction, the positional relationship being determined on the basis of the first depth image illustrated FIG. 3B and the second depth image illustrated FIG. 3D. The image compositing unit 1130 compares each pixel of the first depth image with a corresponding pixel of the second depth image, and determines that the pixel representing a shorter distance with respect to the reference position (that is, the pixel having a value nearer to black) is nearer to the viewpoint. In compositing the virtual images, the image compositing unit 1130 uses the pixels having depth information determined to be nearer to the viewpoint, among corresponding pixels of the respective virtual images.

FIG. 3F illustrates the real image 3010 acquired by the image capturing unit 1010. The MR image illustrated FIG. 3G is an image resultant of causing the image compositing unit 1130 to composite the real image 3010 with the composite image illustrated FIG. 3E.

According to the first embodiment, each of the two information processing apparatuses generates a virtual image from the data of different virtual bodies. One of the information processing apparatuses then generates a composite image by compositing the two virtual images. Therefore, data of all of the virtual bodies to be rendered in the composite image does not need to be stored on one information processing apparatus. Therefore, it is possible to retain the data of a virtual body not desirable to be shared with another information processing apparatus only on one information processing apparatus, for example. With this, it becomes possible to prevent confidential technical information of one company from becoming known to other companies.

### First Modification

In the first embodiment, data related to a light source illuminating the interior of the virtual space has been described as data to be retained on both of the information processing apparatus 110 and the information processing apparatus 120. The data related to a light source illuminating the interior of the virtual space is also common data between the information processing apparatus 110 and the information processing apparatus 120. However, it is also possible to retain the data related to a light source only on one of the information processing apparatus 110 and the information processing apparatus 120. The information processing apparatus 110 may then transmit the data related to the light source retained thereon to the information processing apparatus 120, and the information processing apparatus 120 may generate images using the data received from the information processing apparatus 110. It is also possible for the information processing apparatus 120 to transmit the data related to the light source retained thereon to the information processing apparatus 110, and for the information processing apparatus 110 to generate images using the data received from the information processing apparatus 120. Furthermore, the data related to a light source may be shared between the information processing apparatus 110 and the information processing apparatus 120, and the information processing apparatus 110 or the information processing apparatus 120 may use the whole or a part of such data in generating images.

### Second Embodiment

In a second embodiment, the information processing system includes a plurality of display devices.

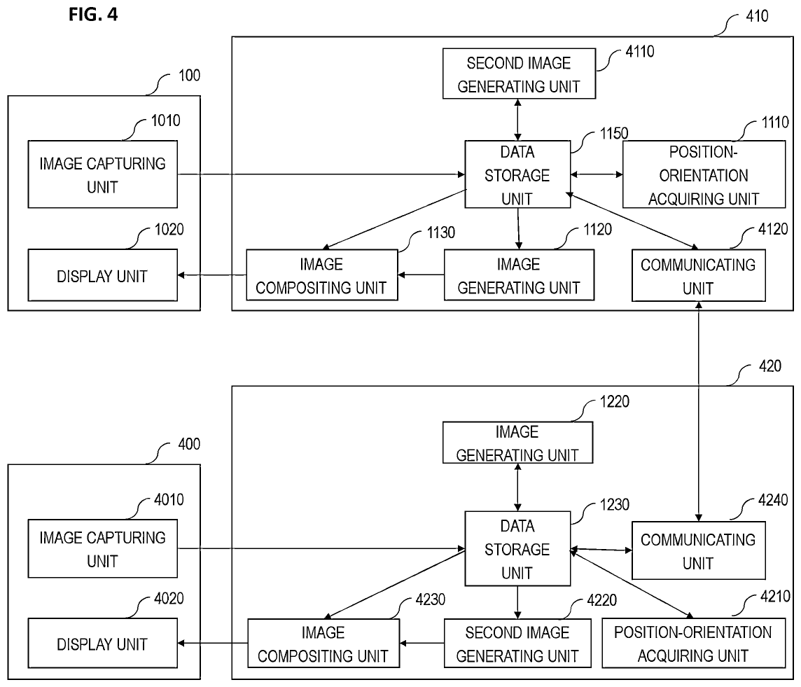

FIG. 4 is a schematic illustrating an exemplary configuration of an information processing system according to a second embodiment. As illustrated in FIG. 4, the information processing system according to the second embodiment includes the display device 100, a display device 400, an information processing apparatus 410, and an information processing apparatus 420. In FIG. 4, parts that are the same as those in FIG. 1 are given the same numbers, and explanations thereof will be omitted.

The display device 400 includes an image capturing unit 4010 and a display unit 4020.

The image capturing unit 4010 captures images of the real space temporally continuously, and outputs the captured images of the real space to the information processing apparatus 420. The image capturing unit 4010 may also include a stereo camera. The stereo camera includes two cameras that are fixed in a manner enabled to capture images of the real space at the positions of respective eyes of the user (viewpoint position), for example, along the direction of the line of sight of the user.

The display unit 4020 displays the MR image output from the information processing apparatus 420. The display unit 4020 may include a display disposed correspondingly to the left eye of the user, and a display disposed correspondingly to the right eye of the user. In such a case, an MR image for the left eye is displayed on the display corresponding to the left eye of the user, and an MR image for the right eye is displayed on the display corresponding to the right eye of the user.

The information processing apparatus 410 is data-communicably connected to the display device 100 and the information processing apparatus 420. The display device 400 and the information processing apparatus 420 are data-communicably connected to each other. The whole or a part of the information processing apparatus 410 may be disposed inside the housing of the display device 100. The whole or a part of the information processing apparatus 420 may be disposed inside the housing of the display device 400. Furthermore, the display device 100, the display device 400, the information processing apparatus 410, and the information processing apparatus 420 may be in the same space, or remote spaces.

The information processing apparatus 410 includes the position-orientation acquiring unit 1110, the image generating unit 1120, the image compositing unit 1130, the data storage unit 1150, a second image generating unit 4110, and a communicating unit 4120. It is also possible for the second image generating unit 4110 to be included in the image generating unit 1120.

The second image generating unit 4110 generates a virtual image on the basis of the data of the virtual space stored in the data storage unit 1150 (hereinafter, referred to as a “third virtual image”). The data of the virtual space includes data related to each of the virtual bodies included in the virtual space, data related to a reality-approximating body that is information of the three-dimensional shape of a real body acquired from the real space, the three-dimensional shape being plotted in the virtual space, and data related to a light source illuminating the interior of the virtual space. The data of the virtual space (virtual bodies) used in generating the third virtual image is the same as the data of the virtual space used in generating the first virtual image. In other words, the first virtual image and the third virtual image both include renderings of identical virtual bodies (e.g., the first virtual bodies). The second image generating unit 4110 but generates an image of the virtual space (virtual bodies) perceived from a viewpoint corresponding to the position-orientation of the image capturing unit 4010, calculated by a position-orientation acquiring unit 4210, as the third virtual image. The second image generating unit 4110 generates a depth image corresponding to the third virtual image (hereinafter, referred to as a “third depth image”).

The communicating unit 4120 transmits the position-orientation information of the image capturing unit 1010 to the information processing apparatus 420. The communicating unit 4120 also transmits the third virtual image and the third depth image generated by the second image generating unit 4110 to the information processing apparatus 420. The communicating unit 4120 also receives the second virtual image and the second depth image generated by the image generating unit 1220, and the position-orientation information of the image capturing unit 4010, calculated by the position-orientation acquiring unit 4210.

The information processing apparatus 420 includes the image generating unit 1220, the data storage unit 1230, the position-orientation acquiring unit 4210, a second image generating unit 4220, an image compositing unit 4230, and a communicating unit 4240. It is also possible for the second image generating unit 4220 to be included in the image generating unit 1220.

The position-orientation acquiring unit 4210 calculates the position-orientation of the image capturing unit 4010 within the world coordinate system. The position-orientation acquiring unit 4210 can calculate the position-orientation of the image capturing unit 4010, in the same manner by which the position-orientation acquiring unit 1110 calculates the position-orientation of the image capturing unit 1010.

The second image generating unit 4220 generates a virtual image to be displayed on the display device 400 (hereinafter, referred to as a “fourth virtual image”) on the basis of the data of the virtual space stored in the data storage unit 1230. The data of the virtual space (virtual bodies) used in generating the fourth virtual image is the same as the data of the virtual space used in generating the second virtual image. In other words, the second virtual image and the fourth virtual image both include renderings of identical virtual bodies (e.g., the second virtual bodies). The second image generating unit 4220 but generates an image of the virtual space (virtual bodies) perceived from a viewpoint corresponding to the position-orientation calculated by the position-orientation acquiring unit 4210, as the fourth virtual image. In the same manner as in the first embodiment, the data of virtual bodies stored in the information processing apparatus 410 is not stored in the information processing apparatus 420, and the data of virtual bodies stored in the information processing apparatus 420 is not stored in the information processing apparatus 410, either.

The second image generating unit 4220 also generates a depth image corresponding to the fourth virtual image (hereinafter, referred to as a “fourth depth image”). The second image generating unit 4220 then outputs the fourth virtual image and the fourth depth image to the image compositing unit 4230.

The image compositing unit 4230 composites the third virtual image and the fourth virtual image. Before compositing the images, the image compositing unit 4230 compares the third depth image with the fourth depth image, and determines which one of the third virtual image and the fourth virtual image is nearer to the viewpoint, in units of pixels. The image compositing unit 4230 then composites the third virtual image with the fourth virtual image in such a manner that the pixels of the virtual image determined to be nearer to the viewpoint are shown. The image compositing unit 4230 then generates an MR image by compositing the composite of the two virtual images with a real space image captured by the image capturing unit 4010. The image compositing unit 4230 then outputs the generated MR image to the display unit 4020.

The communicating unit 4240 transmits the position-orientation information of the image capturing unit 4010, the second virtual image, and the second depth image to the information processing apparatus 410. The communicating unit 4240 also receives the position-orientation information of the image capturing unit 1010, the third virtual image, and the third depth image from the information processing apparatus 410.

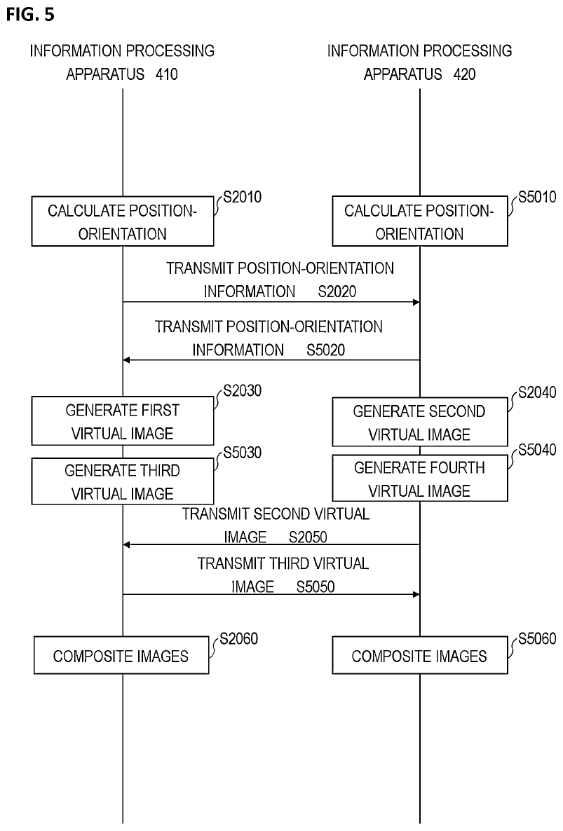

A process performed by the information processing apparatus 410 and the information processing apparatus 420 to generate an MR image will now be explained with reference to the flowchart in FIG. 5. In FIG. 5, the parts that are the same as those in FIG. 2 are given the same numbers, and explanations thereof will be omitted. The order of the steps in the flowchart may be changed, as long as the process does not become inconsistent.

At Step S5010, the position-orientation acquiring unit 4210 calculates the position-orientation of the image capturing unit 4010, substantially simultaneously with the process at Step S2010.

At Step S5020, the communicating unit 4240 transmits the position-orientation information of the image capturing unit 4010 to the information processing apparatus 410. Note that the process at Step S5020 may be performed before the process of Step S2020.

At Step S5030, the second image generating unit 4110 generates a third virtual image and a third depth image on the basis of the position-orientation information of the image capturing unit 4010.

At Step S5040, the second image generating unit 4220 generates a fourth virtual image and a fourth depth image on the basis of the position-orientation information of the image capturing unit 4010, substantially simultaneously with the process at Step S5030.

At Step S5050, the communicating unit 4120 transmits the third virtual image and the third depth image to the information processing apparatus 420. Note that the process at Step S5050 may be performed before the process of Step S2050.

At Step S5060, the image compositing unit 4230 composites the third virtual image, the fourth virtual image, and a real image acquired by the image capturing unit 4010. In the manner described above, the image compositing unit 4230 generates an MR image.

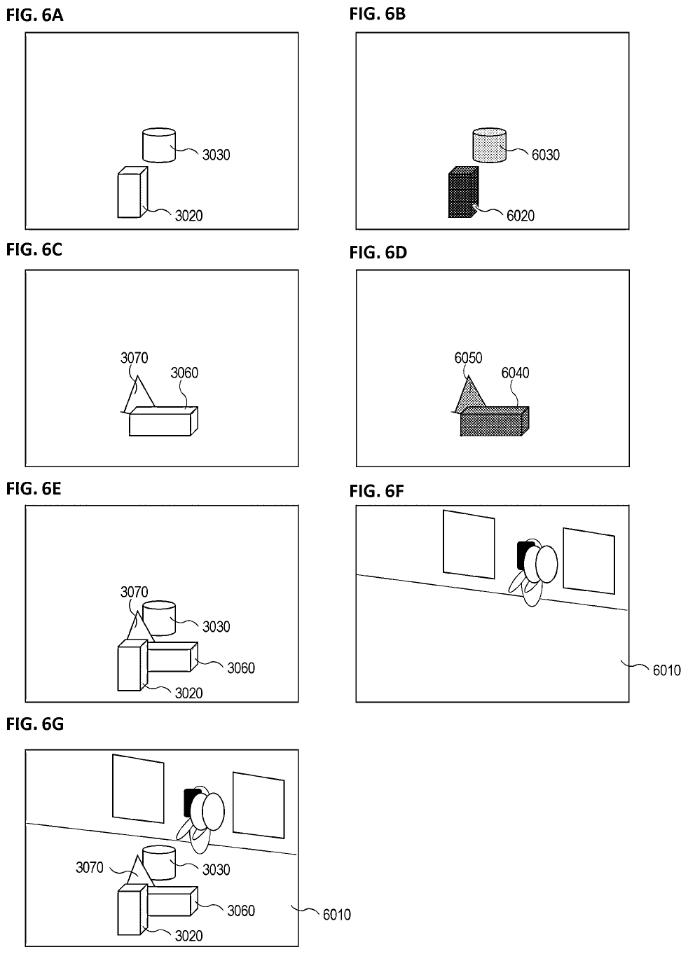

FIGS. 6A to 6G are schematics illustrating examples of the virtual image, the depth image, and the MR image. In FIGS. 6A to 6G, parts that are the same as those in FIGS. 3A to 3G are given the same numbers, and explanations thereof will be omitted. In this example, it is assumed that the display device 400 is positioned behind (on the opposite side of) the display device 100.

A real image 6010 is an image representing the real space. The real image 6010 is an image resultant of causing the image capturing unit 4010 to capture an image of the real space.

A region 6020 is a region where a rendering of the virtual body 3020 is included in the third depth image generated by the second image generating unit 4110. A region 6030 is a region where a rendering of the virtual body 3030 is included in the third depth image generated by the second image generating unit 4110. A region 6040 is a region where a rendering of the virtual body 3060 is included in the fourth depth image generated by the second image generating unit 4220. A region 6050 is a region where a rendering of the virtual body 3070 is included in the fourth depth image generated by the second image generating unit 4220.

FIG. 6A illustrates the third virtual image generated by the second image generating unit 4110. FIG. 6B illustrates the third depth image generated by the second image generating unit 4110. The distance between the virtual body 3020 and the reference position (viewpoint of the display device 400) is shorter than the distance between the virtual body 3030 and the reference position. The other region includes no rendering of bodies. Therefore, in FIG. 6B, the region 6020 is a region darker than the region 6030, and the color of the other region is white.

FIG. 6C illustrates the fourth virtual image generated by the second image generating unit 4220. FIG. 6D illustrates the fourth depth image generated by the second image generating unit 4220. The distance between the virtual body 3060 and the reference position (viewpoint of the display device 400) is shorter than the distance between the virtual body 3070 and the reference position. The other region includes no rendering of bodies. Therefore, in FIG. 6D, the region 6040 is a region darker than the region 6050, and the color of the other region is white.

FIG. 6E illustrates a composite image of the third virtual image with the fourth virtual image, the composite image being composited by the image compositing unit 4230, by comparing the third depth image and the fourth depth image and determining the positional relationship of the virtual bodies in the depth direction. The image compositing unit 4230 compares each pixel of the third depth image with a corresponding pixel the fourth depth image, and determines that the pixel nearer to the reference position (that is, the pixel having a value nearer to black) is nearer to the viewpoint. In compositing the virtual images, the image compositing unit 4230 uses the pixels having depth information determined to be nearer to the viewpoint, among corresponding pixels of the respective virtual images.

FIG. 6F illustrates the real image 6010 resultant of causing the image capturing unit 4010 to capture an image of the real space. The MR image illustrated FIG. 6G is an image resultant of causing the image compositing unit 4230 to composite the real image 6010 with the composite image illustrated FIG. 6E.

In the manner described above, according to the second embodiment, even when a plurality of users perceive the same MR space from different viewpoints, a plurality of information processing apparatuses can generate different virtual images, respectively. In other words, in such a case, too, data of all of the virtual bodies to be rendered in the composite image does not need to be stored on one information processing apparatus. It is therefore possible to retain the data of a virtual body not desirable to be shared with another information processing apparatus only on one information processing apparatus, for example.

### Second Modification

Explained in the second embodiment is an example in which the information processing system includes two display devices, but the information processing system may include three or more display devices. In such a case, after each of the information processing apparatus 410 and the information processing apparatus 420 generates a virtual image that is based on the position-orientation information of the corresponding display device, the resultant two virtual image are composited. Therefore, MR images can be displayed on the respective display devices.

### Third Modification

As a publicly known technology, three-dimensional reconstruction has been known. With the use of the three-dimensional reconstruction, the shape (information) of a virtual body that is a three-dimensional object can be restored (estimated) based on an image including a rendering of the virtual body. That means, a virtual body managed in the information processing apparatus 410 can be restored on the information processing apparatus 420. With such a technology, even when it is desirable to prevent the whole or a part of the information related to the shape of a virtual body from being disclosed to an information processing apparatus belonging to a different administrator or organization, the first and the second embodiment fail to prevent such disclosures.

To address this issue, in a third modification, a specific condition may be provided to determine whether or not a virtual image is to be generated. In the explanation hereunder, an example in which the image generating unit 1120 determines whether a virtual image is to be generated will be explained. The second image generating unit 4110, the image generating unit 1220, and the second image generating unit 4220, too, determine whether to generate a virtual image, in the same manner as the image generating unit 1120.

The specific condition is a condition for determining whether it is appropriate to provide the virtual image (information included in the virtual image) to the information processing apparatus that generate an MR image. An example of the specific condition is a condition that the position-orientation of the image capturing unit 1010 is a specific position-orientation (e.g., a position-orientation in which the image capturing unit 1010 is facing downwards) in the world coordinate system, for example. The specific condition may be a condition that a distance between or an angle formed by each of the virtual bodies and the display device 100 (reference position-orientation) is a specific distance or angle. In other words, the specific condition may be a condition that the relationship between the position-orientation of each of the virtual bodies and the position-orientation of the image capturing unit 1010 is in a specific relationship. The image generating unit 1120 determines whether the specific condition is satisfied on the basis of the position-orientation information of the image capturing unit 1010, or on the basis of the distance between or the angle formed by each of the virtual bodies and the display device 100 (reference position-orientation) in the world coordinate system. The image generating unit 1120 then controls as to whether the first virtual image is to be generated, on the basis of whether the specific condition is satisfied. Specifically, if it is determined that the specific condition is not satisfied, the image generating unit 1120 generates the first virtual image, in the same manner as in the embodiments described above. By contrast, if it is determined that the specific condition is satisfied, the image generating unit 1120 does not generate the first virtual image. In such a case, the display device 100 may display an image of the real space.

When the information processing apparatus 410 directly connected to the display device 100 is to generate a virtual image to be displayed on the display device 100, the information processing apparatus 410 may generate the virtual image regardless whether the specific condition is satisfied. In other words, the image generating unit 1120 may generate the first virtual image regardless whether the specific condition is satisfied. In such a case, because the image compositing unit 1130 does not acquire the second virtual image, the image compositing unit 1130 may generate an image by compositing the first virtual image with the real image, and output the image on the display device 100.

Furthermore, the image generating unit 1120 may also be configured to, when the specific condition is satisfied, modify the first virtual image, the data of the virtual space, or the like, instead of controlling whether or not to generate the first virtual image. For example, the image generating unit 1120 may be configured to, when the specific condition is satisfied, generate the first virtual image after modifying the data related to the light source illuminating the interior of the virtual space, to such a virtual light source creating no shading on the virtual body. The image generating unit 1120 may also be configured to, when the specific condition is satisfied, generate the first virtual image after changing the rendering technique to such a technique creating no shading on the virtual body. The image generating unit 1120 may also project a three-dimensional virtual body onto a predetermined virtual plane, and make the first virtual image appear in the same manner as the ordinary first virtual image only when the first virtual image is perceived from a specific area, for example. In addition, the image generating unit 1120 may also be configured to, when the specific condition is satisfied, reduce the resolution of the rendering of the first virtual image (reduce the total number of pixels).

In other words, when the specific condition is satisfied, the image generating unit 1120 generates such a first virtual image that it is difficult to estimate the shape of the virtual body from the first virtual image (first virtual image from which the shape of the virtual body is less presumable), compared with that generated when the specific condition is not satisfied. More specifically, when the specific condition is satisfied, the image generating unit 1120 uses a smaller amount of information or less precise information of the virtual body included in the first virtual image, compared with that used when the specific condition is not satisfied.

By providing a condition such as that described in the third modification, it is possible to provide a composite image without the need to retain the data of all of the three-dimensional objects in at least one of a plurality of locations, while ensuring the security of the users.

### Third Embodiment

In the first and the second embodiment, elements of each of the information processing apparatuses are all implemented as hardware. However, a part of the information processing apparatuses may be implemented as software. In such a case, by causing a computer implementing the remaining part as hardware to execute software, the computer implements the operations of the information processing apparatuses explained in the embodiment.

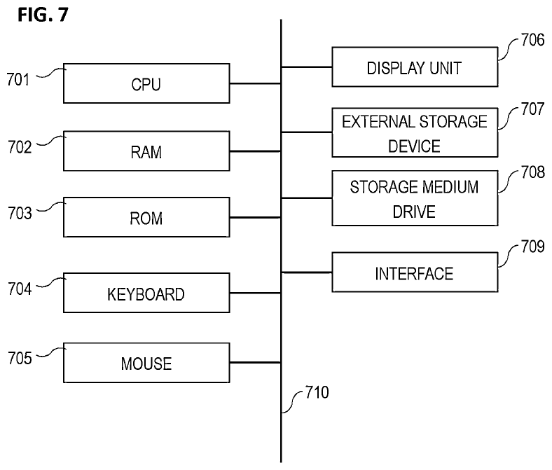

FIG. 7 is a block diagram illustrating a configuration example of hardware of a computer applicable to each of the information processing apparatus 110, the information processing apparatus 120, the information processing apparatus 410, and the information processing apparatus 420. The computer includes a CPU 701, a RAM 702, a ROM 703, a keyboard 704, a mouse 705, a display unit 706, an external storage device 707, a storage medium drive 708, and an interface 709.

The CPU 701 is a control unit that controls the entire computer using a computer program and data stored in the RAM 702 or the ROM 703. The CPU 701 executes the processes to be performed by each of the information processing apparatus 110, the information processing apparatus 120, the information processing apparatus 410, and the information processing apparatus 420.

The RAM 702 has an area for temporarily storing therein a computer program and data loaded from the external storage device 707 or the storage medium drive 708. The RAM 702 also has an area for temporarily storing therein data received from external via the interface 709. The data may be a real image received from the external, for example. The RAM 702 also has a working area used by the CPU 701 in executing each process. In other words, the RAM 702 may provide various areas as appropriate. For example, the RAM 702 also functions as the data storage unit 1150 and the data storage unit 1230.

The ROM 703 stores therein a setting data and a boot program for the computer.

The keyboard 704 and the mouse 705 are input devices (operation members) for receiving user operations. Users of the computer can enter various instructions to the CPU 701 by operating at least one of the keyboard 704 and the mouse 705.

The display unit 706 has a CRT or a liquid crystal display. The display unit 706 can display results of processing executed by the CPU 701, as an image or characters.

The external storage device 707 is a large-capacity information storage device, a representative example of which is a hard disk drive. The external storage device 707 stores therein computer programs (such as an operating system (OS)) and data for causing the CPU 701 to execute the processes having been described to be performed by the information processing apparatuses. Such a computer program includes a computer program executed by elements of the information processing apparatuses in the information processing system. Furthermore, such data includes data of the virtual space and the data explained above as known information.

The computer program and the data stored in the external storage device 707 are loaded onto the RAM 702 as appropriate, under the control of the CPU 701. By executing processing using the loaded computer program and data, the CPU 701 executes the processes having been described as to be performed by the information processing apparatuses. The external storage device 707 may also be used as the data storage unit 1150 and the data storage unit 1230.

The storage medium drive 708 reads computer programs and data stored in a storage medium (such as a CD-ROM or DVD-ROM). The storage medium drive 708 may write computer programs and data to the storage medium. The whole or a part of the computer program and data explained to be stored in the external storage device 707 may be stored in this storage medium. The computer program and data read by the storage medium drive 708 from the storage medium is output to the external storage device 707 or to the RAM 702.

The interface 709 is an interface for connecting the image capturing unit 1010 and the image capturing unit 4010. The interface 709 includes an analog video port or a digital input/output port (e.g., IEEE 1394). The interface 709 has an Ethernet (registered trademark) port for making outputs to the display unit 1020 and the display unit 4020. Data input via the interface 709 is output to the RAM 702 or the external storage device 707. When a sensor system is used in acquiring the position-orientation information, the sensor system is also connected to the interface 709.

The bus 710 is a bus for connecting the components described above.

According to the present invention, a composite image of a plurality of images can be provided without having at least one device retain the information of all of the three-dimensional objects included in the composite image of the plurality of images.

Although the present invention has been described above on the basis of the embodiments, the present invention is not limited to these specific embodiments, and various embodiments within the scope not deviating from the essence of the present invention still fall within the scope of the present invention. Some parts of the embodiments may be combined as appropriate.

In the description above, expressions such as “if A is at least B, the system control goes to Step S1, and if A is smaller (lower) than B, the system control goes to Step S2” may also be read as “if A is greater (higher) than B, the system control goes to Step S1, and if A is not greater than B, the system control goes to Step S2”. Conversely, expressions such as “if A is greater (higher) than B, the system control goes to Step S1, and if A is not greater than B, the system control goes to Step S2” may also be read as “if A is at least B, the system control goes to Step S1, and if A is smaller (lower) than B, the system control goes to Step S2”. In this manner, the phrase “at least A” may also be read as “greater (higher; longer; more) than A”, and the phrase “not greater than A” may also be read as “smaller (lower; shorter; less) than A”, as long as such reading does not cause any inconsistency. The phrase “greater (higher; longer; more) than A” may also be read as “at least A”, and the phrase “smaller (lower; shorter; less) than A” may also be read as “not greater than A”.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-219229, filed on Dec. 26, 2023, which is hereby incorporated by reference herein in its entirety.

What is claimed is:

1. An information processing system comprising a first information processing apparatus that stores information of a first object, and a second information processing apparatus that stores information of a second object different from the first object, wherein
the first information processing apparatus performs first generating processing to generate a first image including a rendering of the first object, based on position-orientation information of a first body and information of the first object,
the second information processing apparatus performs second generating processing to generate a second image including a rendering of the second object, based on the position-orientation information of the first body and information of the second object, and
the first information processing apparatus further performs first compositing processing to generate an image that is a composite of the first image and the second image.

2. The information processing system according to claim 1, wherein
in the first generating processing, a first depth image representing depth information corresponding to each pixel of the first image is further generated,
in the second generating processing, a second depth image representing depth information corresponding to each pixel of the second image is further generated, and
in the first compositing processing, an image that is a composite of the first image and the second image is generated, based on the first depth image and the second depth image.

3. The information processing system according to claim 1, wherein
in the first generating processing, a third image including a rendering of the first object is generated, based on position-orientation information of a second body and the information of the first object,
in the second generating processing, a fourth image including a rendering of the second object is generated, based on the position-orientation information of the second body and the information of the second object, and
the second information processing apparatus further performs second compositing processing to generate an image that is a composite of the third image and the fourth image.

4. The information processing system according to claim 1, wherein
in the second generating processing, the second image is not generated in a first case where a specific condition having been preset is satisfied, and
in the second generating processing, the second image is generated in a second case where the specific condition is not satisfied.

5. The information processing system according to claim 1, wherein
the second object is a three-dimensional object, and
in a first case where a specific condition having been preset is satisfied, in the second generating processing, the second image is generated making a shape of the second object less presumable, than in a second case where the specific condition is not satisfied.

6. The information processing system according to claim 5, wherein
the second image generated in the first case has a less total number of pixels than a total number of pixels in the second image generated in the second case.

7. The information processing system according to claim 5, wherein
the second object is not shaded in the second image generated in the first case.

8. The information processing system according to claim 5, wherein,
in the first case, in the second generating processing, the second image is generated based on information resultant of modifying information of the second object.

9. The information processing system according to claim 4, wherein
the specific condition is a condition that a position-orientation of the first body is a specific position-orientation.

10. The information processing system according to claim 4, wherein
the specific condition is a condition that a relationship between a position-orientation of the first body and a position-orientation of the second object is in a specific relationship.

11. The information processing system according to claim 4, wherein
the first object is a three-dimensional object, and
in the first case, in the first generating processing, the first image is generated making a shape of the first object less presumable, than in the second case.

12. The information processing system according to claim 1, wherein at least one of the first object and the second object is a three-dimensional object representing a body disposed in a real space.

13. The information processing system according to claim 1, wherein
the first information processing apparatus does not store information of the second object, and
the second information processing apparatus does not store information of the first object.

14. A method of controlling an information processing system comprising a first information processing apparatus that stores information of a first object, and a second information processing apparatus that stores information of a second object different from the first object, the method comprising:
a first generating step of generating a first image including a rendering of the first object, based on position-orientation information of a first body and information of the first object, on the first information processing apparatus;
a second generating step of generating a second image including a rendering of the second object based on the position-orientation information of the first body and information of the second object, on the second information processing apparatus; and
a first compositing step of generating an image that is a composite of the first image and the second image on the first information processing apparatus.

15. A non-transitory computer readable medium that stores a program, wherein the program causes a computer to execute a method of controlling an information processing system comprising a first information processing apparatus that stores information of a first object, and a second information processing apparatus that stores information of a second object different from the first object, the method comprising:
a first generating step of generating a first image including a rendering of the first object, based on position-orientation information of a first body and information of the first object, on the first information processing apparatus;
a second generating step of generating a second image including a rendering of the second object based on the position-orientation information of the first body and information of the second object, on the second information processing apparatus; and
a first compositing step of generating an image that is a composite of the first image and the second image on the first information processing apparatus.
